(19) United States
(12) Patent Application Publication
(10) Pub. No.: US 2022/0091398 A1
(43) Pub. Date: Mar. 24, 2022

(54) Telephoto Camera with a Stationary Optics Assembly

(71) Applicant: Apple Inc., Cupertino, CA (US)

(72) Inventors: Nicholas D. Smyth, San Jose, CA (US); Scott W. Miller, Los Gatos, CA (US); Douglas S. Brodie, Los Gatos, CA (US); Michael B. Wittenberg, San Francisco, CA (US); James A. Bertin, San Jose, CA (US); David A. Pakula, San Francisco, CA (US); Yoshikazu Shinohara, Cupertino, CA (US)

(73) Assignee: Apple Inc., Cupertino, CA (US)

(21) Appl. No.: 17/481,210

(22) Filed: Sep. 21, 2021

Related U.S. Application Data
(60) Provisional application No. 63/083,042, filed on Sep. 24, 2020.
(60) Provisional application No. 63/173,279, filed on Apr. 9, 2021.

(51) Int. Cl. G02B 13/00; H04N 5/225; G02B 7/09; G03B 5/00

(52) U.S. Cl. CPC G02B 13/0065; H04N 5/2253; H04N 5/2254; G03B 2205/0069; G02B 7/09; G03B 5/00; H04N 5/2257

(57) ABSTRACT

A camera may include an image sensor and an optics assembly that may include a light folding element and a lens group having one or more lenses. The light folding element may be placed optically between the image sensor and the lens group, and may redirect light passing through the lens group to the image sensor. The optics assembly may be stationarily attached to a stationary base of the camera, which may be further attached to a stationary housing of the camera. The image sensor may be moved, e.g., using an actuator, in multiple axes relative to the optics assembly to implement autofocus (AF) and/or optical image stabilization (OIS) functions.

### BACKGROUND

This application claims benefit of priority to U.S. Provisional Application Ser. No. 63/083,042, entitled “Telephoto Camera,” filed Sep. 24, 2020, and claims benefit of priority to U.S. Provisional Application Ser. No. 63/173,279, entitled “Telephoto Camera with A Stationary Optics Assembly,” filed Apr. 9, 2021, and which are hereby incorporated herein by reference in their entirety.

### TECHNICAL FIELD

This disclosure relates generally to telephoto cameras and more specifically to telephoto cameras that may include a stationarily-mounted optics assembly having a light folding element and an image sensor movable relative to the optics assembly in multiple axes.

### DESCRIPTION OF THE RELATED ART

Telephoto cameras generally have relatively long focal lengths and are great for capturing objects at a far distance with relatively high zoom factors. However, the advent of small, mobile multipurpose devices such as smartphones, tablet, pad, or wearable devices has created a need for high-resolution, small form factor telephoto cameras for integration in the devices. Therefore, it is desirable to have a high-zoom telephoto camera architecture fitting for such system integrations.

### BRIEF DESCRIPTION OF THE DRAWINGS

FIGS. 1A-1B show an example telephoto camera, according to some embodiments.

FIGS. 2A-2B show another example telephoto camera, according to some embodiments.

FIGS. 3A-3C are schematic cross-sectional views to show mounting of an optics assembly in an example camera, according to some embodiments.

FIG. 4 is an exploded view to show mounting of an optics assembly in an example camera, according to some embodiments.

FIGS. 5A-5C show an example light folding element including aperture masks, according to some embodiments.

FIG. 6 shows a high-level flowchart showing example techniques and methods for capturing images using a camera, according to some embodiments.

FIG. 7 shows a high-level flowchart showing example techniques and methods for creating an optical system of a camera, according to some embodiments.

FIG. 8 is a high-level flowchart showing example techniques and methods for mounting an optics assembly in a camera, according to some embodiments.

FIG. 9 shows a schematic representation of an example device that may include a camera, according to some embodiments.

FIG. 10 shows a schematic block diagram of an example computer system that may include a camera, according to some embodiments.

This specification includes references to “one embodiment” or “an embodiment.” The appearances of the phrases “in one embodiment” or “in an embodiment” do not necessarily refer to the same embodiment. Particular features, structures, or characteristics may be combined in any suitable manner consistent with this disclosure.

“Comprising.” This term is open-ended. As used in the appended claims, this term does not foreclose additional structure or steps. Consider a claim that recites: “An apparatus comprising one or more processor units . . . ” Such a claim does not foreclose the apparatus from including additional components (e.g., a network interface unit, graphics circuitry, etc.).

“Configured To.” Various units, circuits, or other components may be described or claimed as “configured to” perform a task or tasks. In such contexts, “configured to” is used to connote structure by indicating that the units/circuits/components include structure (e.g., circuitry) that performs those task or tasks during operation. As such, the unit/circuit/component can be said to be configured to perform the task even when the specified unit/circuit/component is not currently operational (e.g., is not on). The units/circuits/components used with the “configured to” language include hardware—for example, circuits, memory storing program instructions executable to implement the operation, etc. Reciting that a unit/circuit/component is “configured to” perform one or more tasks is expressly intended not to invoke 35 U.S.C. § 112(f) for that unit/circuit/component. Additionally, “configured to” can include generic structure (e.g., generic circuitry) that is manipulated by software and/or firmware (e.g., an FPGA or a general-purpose processor executing software) to operate in manner that is capable of performing the task(s) at issue. “Configure to” may also include adapting a manufacturing process (e.g., a semiconductor fabrication facility) to fabricate devices (e.g., integrated circuits) that are adapted to implement or perform one or more tasks.

“First,” “Second,” etc. As used herein, these terms are used as labels for nouns that they precede, and do not imply any type of ordering (e.g., spatial, temporal, logical, etc.). For example, a buffer circuit may be described herein as performing write operations for “first” and “second” values. The terms “first” and “second” do not necessarily imply that the first value must be written before the second value.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While in this case, B is a factor that affects the determination of A, such a phrase does not foreclose the determination of A from also being based on C. In other instances, A may be determined based solely on B.

It will also be understood that, although the terms first, second, etc. may be used herein to describe various elements, these elements should not be limited by these terms. These terms are only used to distinguish one element from another. For example, a first contact could be termed a second contact, and, similarly, a second contact could be termed a first contact, without departing from the intended scope. The first contact and the second contact are both contacts, but they are not the same contact.

The terminology used in the description herein is for the purpose of describing particular embodiments only and is not intended to be limiting. As used in the description and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

### DETAILED DESCRIPTION

A telephoto camera is generally great for capturing the object, especially at a far distance, because of its long focal length, e.g., 60 millimeters or longer. The telephoto camera generally has a long focal length, which can magnify and thus provide a high-quality image of the distant object.

However, a conventional telephoto camera is fundamentally limited with respect to two important optical parameters—F-number and zoom factor. The F-number refers to a ratio between the camera's focal length to the diameter of the aperture stop of the camera. It is generally desirable to have a low F-number, meaning a wider aperture opening (for a given focal length) which allows more light to be captured for creating a higher image quality. But due to the long focal length, it is generally difficult to achieve a low F-number for conventional telephoto cameras. The zoom factor refers to a ratio of the focal length of the camera with respect to a “reference” focal length, e.g., the focal length of a wide angle camera. It is generally preferred to have a large zoom factor so that the camera can have a higher image magnification. However, the large zoom factor requires a long optical total track length (TTL). The TTL refers to the light traveling distance along the optical axis from the front surface of the first lens (facing objects in the environment) of the camera to the image plane at the image sensor. An increase of the TTL can increase the size of the camera and thus making it unfit for integration in small, mobile multipurpose devices.

Various embodiments described herein relate to a high-zoom telephoto camera architecture with improved fit for integration in small form factor, mobile devices. In some embodiments, the camera may include a lens group having one or more lenses, a light folding element, and an image sensor. In some embodiments, the light folding element may reflect (or fold) light to guide the light to the lenses and/or image sensor. In some embodiments, the light folding element may have an elongated shape with a length extending in a direction orthogonal to the optical axis of the lens group larger than a height extending in a direction parallel to the optical axis. In some embodiments, the light folding element may include an elongated prism (e.g., a parallelogram prism) having multiple (e.g., at least four) surfaces. In some embodiments, the elongated prism may pass through light captured by the lenses through a first surface of the prism. At least some of the light may arrive at and then become reflected at the second surface of the prism—e.g., the light being folded once. At least some of the light reflected from the second surface of the prism may be reflected back to the first surface of the prism. When the incident angle of the light is close to or larger than a critical angle of the prism, total internal reflection (TIR) may occur and the light may thus be reflected at the first surface of the prism—e.g., the light being folded twice. At least some of the light reflected from the first surface may transmit to and get reflected at the third surface prism—e.g., the light being folded three times. Next, at least some of the light reflected from the third surface of the prism may reach and be reflected at the fourth surface of the prism, and exit the prism to focus on to an image plane on the image sensor—e.g., the light being folded four times. The light folding by the light folding element may effectively increase the focal length and optical TTL of the camera. This may help the telephoto camera to achieve a low F-number and/or a high zoom factor without sacrificing the size of the camera.

The lens group and the light folding element, collectively, may be referred to as an optics assembly. Because it includes both the lens(es) and the light folding element, the optics assembly may have a relatively significant weight. Therefore, in some embodiments, the camera may shift the relatively lighter-weight image sensor in multiple axes relative to the optics assembly, e.g., to implement both autofocus (AF) and optical image stabilization (OIS) functions, whilst maintaining the optics assembly stationary. For instance, the image sensor may be moved, e.g., by an actuator such as a voice coil motor (VCM) actuator, relative to the optics assembly in a direction approximately parallel to the optical axis (e.g., Z-axis) of the lens group of the optics assembly to implement the AF function. Further, the image sensor may be moved relative to the optics assembly in at least another direction (e.g., X- and/or Y-axis) approximately orthogonal to the optical axis (e.g., Z-axis) of the lens group to implement the OIS function. In short, the image sensor may possess at least two degrees of freedom. Note that the term “stationary” does not necessarily mean that the optics assembly would never move, but rather that the optics assembly is not moved, e.g., by an actuator, purposefully. For instance, when the camera experiences sudden movement (e.g., a drop), the optics assembly may move or shake inside the camera. However, such movement of the optics assembly is not caused by an actuator on purpose.

In some embodiments, the movement of the image sensor may be controlled based at least in part on its position relative to the optics assembly that is deemed stationary. Therefore, secure mounting of the optics assembly is critical to performance of the functions (e.g., AF and/or OIS functions) of the telephoto camera. In some embodiments, the mounting of the optics assembly may include attaching the optics assembly to a stationary base so that the two become fixedly coupled with each other, and the stationary base may be further attached to or fixedly coupled with a stationary housing of the camera. In some embodiments, the optics assembly may become at least partially placed within the stationary base, and the stationary base may become at least partially placed within the housing of the camera.

The optics assembly may be mounted to the stationary base in various ways. For instance, the optics assembly may be placed within a plastic optics holder, and the stationary base may include a frame (e.g., a metal frame insert-molded in to a non-metal (e.g., plastic) portion of the stationary base). The optics assembly may thus be attached to the stationary base at least at one portion of the metal frame, e.g., by gluing the plastic optics holder to that portion of the metal frame of the stationary base. In another example, the stationary base may include a plastic portion, and the optics assembly may be attached to the plastic portion of the stationary base using plastic welding—e.g., welding the plastic optics holder with the plastic portion of the stationary base altogether. In still another example, the stationary base may be entirely made of metal, e.g., using a computer numerical control (CNC) machining process. Accordingly, the optics assembly may be fixedly coupled with the stationary base, e.g., by gluing the plastic optics holder directly to the metal stationary base. Note that the above are only a few examples provided for purposes of illustration. In some embodiments, the optics holder and the stationary base may use various materials, have various shapes, and the two may be attached with each other using various appropriate approaches. Similarly, the housing of the camera may use various materials, and the stationary base may be attached to the housing in various appropriate ways based, at least in part, on the materials of the components.

The disclosed designs and techniques regarding the telephoto camera provide several benefits. For instance, the use of the light folding element may reduce the size of the camera, e.g., along the optical axis (or Z-axis) of the lens group. In addition, spatially fixing the optics assembly but allowing the image sensor movable enables the telephoto camera to achieve extended TTL and focal length in a compact footprint (with the light folding element) but also implement AF and/or OIS functions (with the image sensor shift design). Next, materials of the optics holder, stationary base, and/or housing may be selected to accommodate various stiffness requirements. Further, the geometry of the optics holder, stationary base, and/or housing may also be designed for different joining methods and/or stiffness requirements.

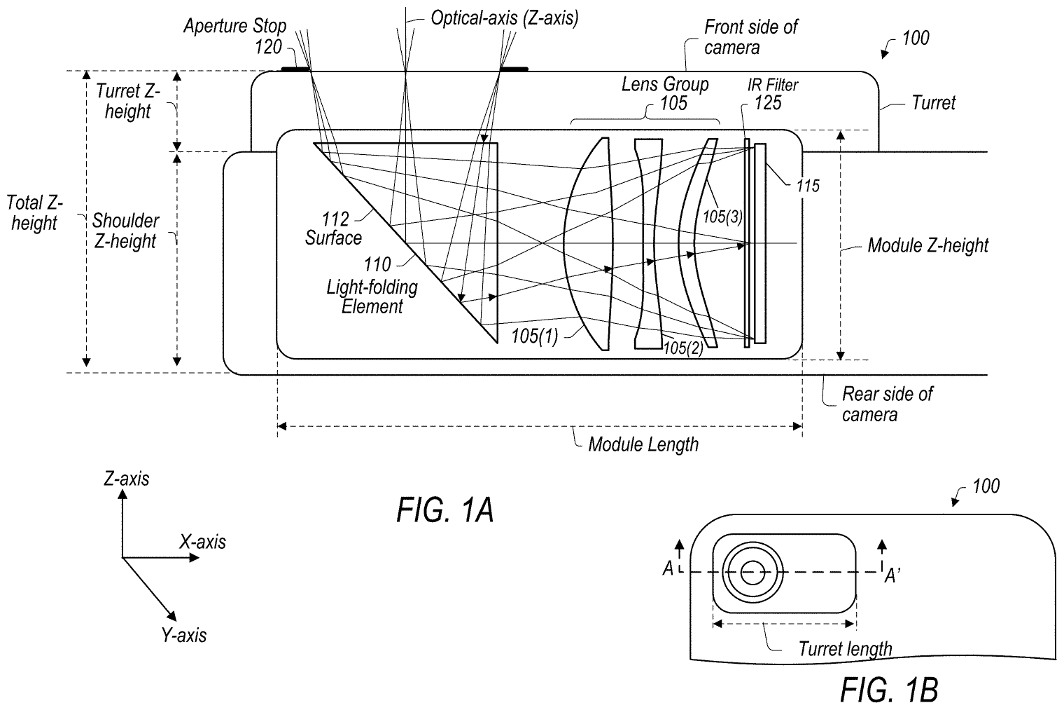

FIGS. 1A-1B show an example telephoto camera, according to some embodiments. In this example, FIG. 1A shows a cross-sectional view of camera 100 (e.g., a telephoto camera) from a perspective indicated by the dashed line A-A′ in FIG. 1B. As shown in FIG. 1A, camera 100 may include lens group 105 including one or more lenses (e.g., lens 105(1), lens 105(2), and lens 105(3)), light folding element 110, and image sensor 115. In some embodiments, camera 100 may include aperture stop 120 which may limit and control the amount of light entering camera 100. In some embodiments, camera 100 may optionally include infrared filter (IF) 125, as shown in FIG. 1, which may block or prevent at least some infrared light from reaching image sensor 115. In some embodiments, light folding element 110 may include a triangular prism, as shown in FIG. 1. In some embodiments, light folding element 110 may simply include a mirror. Regardless of whether it is a triangular prism, a mirror, or other types of suitable light folding elements, light folding element 110 may include reflective surface 112. In some embodiments, light may enter light folding element 110 (e.g., from aperture stop 120 of camera 100), be folded or redirected (e.g., by reflection) from one direction (e.g., along optical axis or Z-axis) to another direction (e.g., along X-axis) at reflective surface 112 of light folding element 110 to lens group 105, pass through lens group 105, and reach image sensor 115, as indicated by the edges in FIG. 1A.

Comparing to the conventional telephoto camera described above, camera 100 may have a reduce total Z-height (measured approximately between a front side and a rear side of camera 120 in a direction parallel to the optical axis of camera 100) by using light folding element 110 to effectively increase the optical TTL. Here, because the light traveling path is folded, the TTL of camera 100 may be the sum of the absolute values of the distances along the folded axis, between the object facing surface and the reflecting surface (surface 112) of light folding element 110 and between the reflecting surface (surface 112) of light folding element 110 and the image plane of image sensor 115. However, by including lens group 105 in a same module together with folding element 110 and image sensor 115, camera 100 may have to increase the module length and even the length of the turret, as shown in FIG. 1A. In some embodiments, camera 100 may be integrated into a mobile device, such as a smartphone, tablet, pad, or wearable device. Here, the term “turret” may broadly refer to a portion of the housing of the mobile device that protrudes or sticks out of the surface of the housing, e.g., in a direction parallel to the optical axis of lens group 105 as shown in FIG. 1A. Sometimes, the turret is also called a “camera bump.” Given that the turret of the mobile device provides some extra space, camera 100 may be positioned such that at least some components of camera 100 may extend into the turret. For instance, in some embodiments, the module housing lens group 105, light folding element 110, and image sensor 115 may occupy at least part of the protruding turret in order to provide spaces for other components of camera 100 to be integrated in the mobile device. Note that technically the optical axis may exist in multiple directions, e.g., a first portion incident on light-folding element 110 (e.g., along Z-axis) and a second portion between lens group 105 and image sensor 115 (e.g., along X-axis). For purposes of discussion and defining relevant directions, the term “optical axis” refers only to the portion passing through a lens group (e.g., lens group 105 along Z-axis) in various embodiments described in this disclosure.

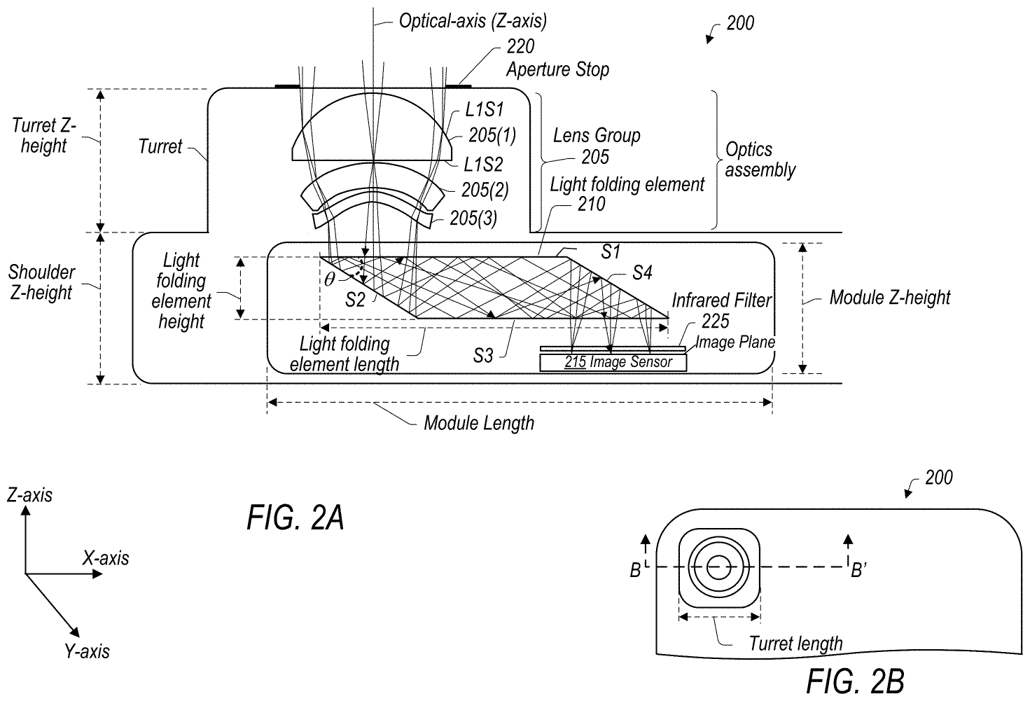

FIGS. 2A-2B shows another example telephoto camera, according to some embodiments. In this example, FIG. 2A shows a cross-sectional view of camera 200 (e.g., a telephoto camera) from a perspective indicated by the dashed line B-B′ in FIG. 2B. In this example, camera 200 may include lens group 205, light folding element 210, and image sensor 215. In some embodiments, lens group 205 may include one or more lenses, e.g., lens 205(1) L1, lens 205(2) L2, and lens 205(3) L3. The lenses (e.g., lens 205(1) L1, lens 205(2) L2, and lens 205(3) L3) may individually include at least a front surface facing light from an environment and a rear surface opposite to the front surface, e.g., as indicated by L1S1 and L1S2 for lens 205(1) L1 in FIG. 2. In some embodiments, camera 200 may include aperture stop 220 arranged in front of lens group 205 to limit and control the amount of light captured by lens group 205. In some embodiments, camera 200 may optionally include infrared filter (IF) 225, as shown in FIG. 2A, which may be arranged in front of image sensor 215 to block or prevent at least some infrared light from reaching image sensor 215. In some embodiments, camera 200 may include one or more actuators for moving lens group 205 and/or image sensor 215. In some embodiments, the actuators may be implemented using voice coil motors. For instance, camera 200 may include an axial motion voice coil motor actuator (not shown in FIG. 2A) which may be controlled to move individual lenses (e.g., lens 205(1) L1, lens 205(2) L2, and/or lens 205(3) L3) of lens group 205, e.g., along the optical axis (or Z-axis) of lens group 205 relative to image sensor 215, to implement various autofocus as well as zoom-in/zoom-out functions. In addition, in some embodiments, camera 200 may include a transverse motion voice coil motor actuator (not shown in FIG. 2A) which may be controlled to move image sensor 215, e.g., relative to lens group 205 along X and/or Y axes orthogonal to the optical axis (or Z-axis) of lens group 205, to implement various optical image stabilization (OIS) functions. But note that FIGS. 2A-2B are presented only as an example for purposes of illustration and not intended to limit implementations of the present disclosure. Therefore, movement of the components of camera 200 may be designed in various ways. For instance, in some embodiments, lens group 205 may be fixed, and only image sensor 215 may be movable.

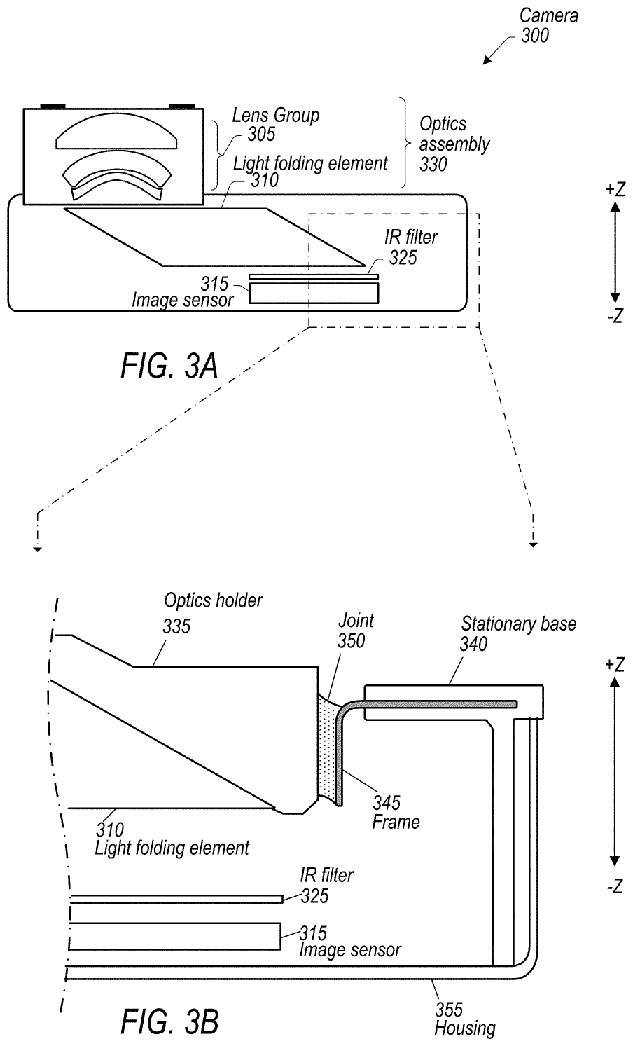

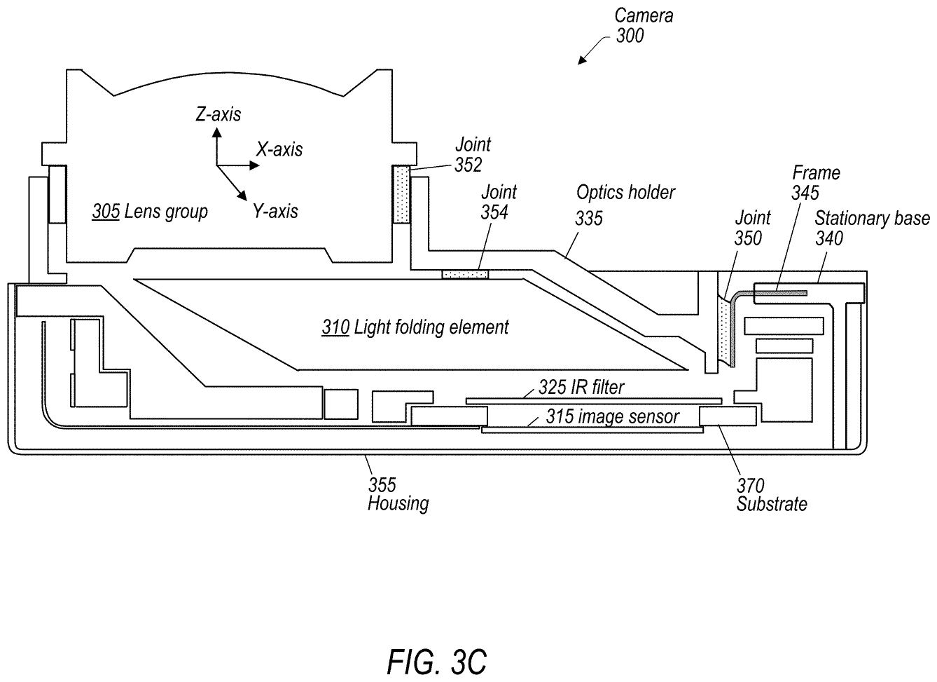

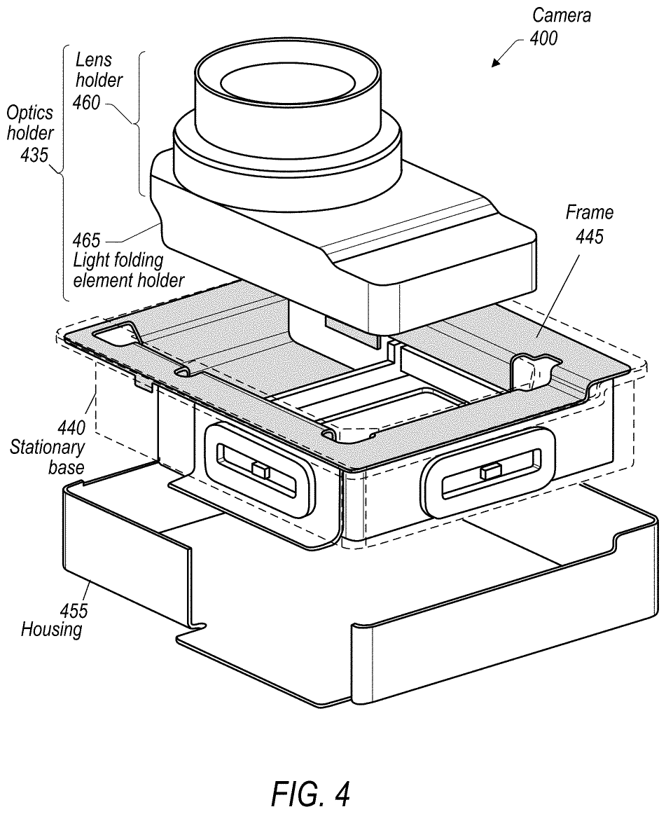

As described above, in some embodiments, lens group 205 and light folding element 210 may be mounted stationarily, whilst only image sensor 215 may be movable. For instance, the optics assembly (including lens group 205 and light folding element 210) of camera 200 may be stationarily mounted to a stationary base, which may be further mounted to a stationary housing of camera 200 (as described in more detail in FIGS. 3-4). Camera 200 may include one or more actuators, e.g., one or more VCM actuators (not shown in FIG. 2), which may include one or more spatially fixed magnets and one or more coils fixedly coupled with image sensor 215 (e.g., through one or more interfacing components). Current flowing through the coils may be regulated, which may in turn interact with the magnetic fields of the magnets to generate motive force (e.g., Lorentz) to move image sensor 215 in the multiple directions. In some embodiments, image sensor 215 may be movable relative to lens group 205 and light folding element 210 in multiple axes, e.g., in (1) a direction approximately parallel to the optical axis (or Z-axis) of lens group 205 and (2) one or more directions (e.g., X- and/or Y-axis) approximately orthogonal to the optical axis (or Z-axis) of lens group 205. Note that the AF and OIS functions are described only as examples for purposes of illustration. In some embodiments, shift of image sensor 215 may be used to implement other functions as well.

In some embodiments, as shown in FIG. 2A, image sensor may be positioned incident to an optical axis (or Z-axis) defined by lens group 205. In some embodiments, light folding element 210 may be arranged, optically, between lens group 205 and image sensor 215 along the optical transmitting path of light from lens group 205 to image sensor 215. In some embodiments, light folding elements 210 may have an elongated shape with a thin height or thickness—e.g., the length of light folding element 210 in a direction (e.g., along X-axis) orthogonal to the optical axis (or Z-axis) is larger than the height or thickness of light folding element 210 in a direction parallel to the optical axis (or Z-axis) of lens group 205. In some embodiments, light folding element 210 may include at least four surfaces. For instance, as shown in FIG. 2A, light folding element 210 may include a parallelogram prism, while a first surface (Surface S1) of light folding element 210 is parallel to a third surface (Surface S3) of light folding element 210 and a second surface (Surface S2) of light folding element 210 is parallel to a fourth surface (Surface S4) of light folding element 210. In some embodiments, light folding element 210 may be arranged such that the first surface (Surface S1) may face lens group 205, whilst the third surface (Surface S3) may face image sensor 215. In some embodiments, the front surface of the first lens (e.g., surface L1S1 of lens 205(1) L1) of lens group 205 may be approximately parallel to an image plane of image sensor 215, such that light incident at the front surface of the first lens 205(1) L1 may be parallel to light incident at the image plane of image sensor 215.

In some embodiments, the second surface (Surface S2) and/or fourth surface (Surface S4) of light folding element 210 may be individually configured to reflect light (e.g., light at wavelengths that are imaged by camera 200). For instance, the second surface (Surface S2) and/or fourth surface (Surface S4) of light folding element 210 may include a reflective coating, placed against a reflective component, or with an interface that allows for total internal reflection (TIR). TIR is a phenomenon that may occur when the incident angle of light is close to or greater than a certain limiting angle, called the critical angle. An incident angle refers to an angle between the light incident on a surface and the line (called the normal) perpendicular to the surface at the point of incidence. In this example, the second surface (Surface S2) and/or fourth surface (Surface S4) of light folding element 210 may use mirror coating based on a thin layer of metal, a film with a white inner surface, and the like to implement a layer of reflective coating. Therefore, the second (Surface S2) and fourth surfaces (Surface S4) of light folding element 210 may reflect light at respective surfaces. The first (Surface 51) and third surfaces (Surface S3) of light folding element 210 may transmit light or pass light through respective surfaces. In addition, the first (Surface S1) and third surfaces (Surface S3) of light folding element 210 may reflect light under TIR, e.g., when the incident angle of the light is close to or greater than the critical angle. Therefore, the first surface (Surface S1) and third surface (Surface S3) of light folding element 210 may pass through light when the incident angle of the light is less than the critical angle. Conversely, when the incident angle of light is close to or greater than the critical angle, the first (Surface S1) and third surfaces (Surface S3) of light folding element 210 may reflect the light at respective surfaces. In some embodiments, the first (Surface S1) and/or third surfaces (Surface S3) of light folding element 210 may further individually include an anti-reflective coating.

Referring back to FIG. 2A, light folding element 210 may fold light within light folding element 210 multiple times to guide the light from lens group 105 passing through light folding element 210 to image sensor 215. For instance, as for light folding element 210 using a parallelogram prism shown in FIG. 2A, light from lens group 205 may pass through the first surface (Surface S1) of light folding element 210 to enter light folding element 210. At least some of the light may arrive at and then get reflected at the second surface (Surface S2) of light folding element 210, as indicated by the edges in FIG. 2A-e.g., the light being folded once. At least some of the light reflected from the second surface (Surface S2) of light folding element 210 may bounce back to the first surface (Surface S1) of light folding element 210, as indicated by the edges in FIG. 2A. When the incident angle of the light is close to or greater than the critical angle of light folding element 210, the light may be reflected at the first surface (Surface S1) of light folding element 210 under TIR—e.g., the light being folded twice. Next, at least some of the light reflected from the first surface (Surface S1) may transmit to and become reflected at the third surface prism (Surface S3) of light folding element 210—e.g., the light being folded three times. Finally, at least some of the light reflected from the third surface (Surface S3) of light folding element 210 may reach the fourth surface (Surface S4) of light folding element 210, get reflected at the fourth surface (Surface S4), and exit light folding element 210 to focus on an image plane of image sensor 215—e.g., the light being folded four times. Therefore, in this example of FIG. 2A, at least some light passing through lens group 205 may be folded four times within light folding element 210 before it exits light folding element 210 to image sensor 215.

Compared to camera 100 in FIG. 1A, camera 200 may move lens group 205 outside the module housing light folding element 210 and image sensor 115 to the turret of a mobile device into which camera 200 is integrated. The use of the turret to accommodate lens group 205 may benefit the spacing of camera 200. Because the turret protrudes outside the housing of the mobile device (as shown in FIG. 2A), the placement of lens group 205 within the turret may leave extra spaces for other components inside camera 200. As a result, the module of camera 200 may primarily need to house only light folding element 210—an elongated prism with thin thickness—and image sensor 215 (and optional infrared filter 225). Thus, this may reduce at least the module Z-height (and shoulder Z-height) of camera 200, as shown in FIG. 2A. Thus, the architecture of camera 200 may allow for a larger aperture opening—thus a lower F-number—for camera 200 with the shorter module Z-height.

For instance, in some embodiments, the thickness of light folding element 210 may be in a range of 2 and 4.1 millimeters. In some embodiments, an angle between the first surface (Surface S1) and the second surface (Surface S2) of light folding element 210 may be in a range between 25 and 35 degrees (e.g., 25<θ<35 degrees). In some embodiments, the F-number may be in a range between 2.2 and 2.8. In some embodiments, the module Z-height of camera 200 may be in a range between 8 to 10 millimeters. In addition, light folding element 210 may fold light multiple times (or more than once, e.g., at least four times). Compared to camera 100 in FIG. 1A which folds light only once, the use of light folding element 200 may allow for an effective increase of the focal length and optical TTL between lens group 105 and image sensor 115 of camera 200—thus a large zoom factor—within a shorter module length. For instance, in some embodiments, the zoom factor of camera 200 may reach 5 or larger, whilst the zoom factor of camera 100 in FIG. 1A may be in a range between 3 and 5. In some embodiments, the module length of camera 200 may be 21 millimeters or less, whilst the module length of camera 100 may be in a range between 21 and 23 millimeters. In some embodiments, the effective focal path of camera 200 may reach a range of 17.2 and 27.2 millimeters. Moreover, as shown in FIG. 2A, the turret may protrude outside of camera 200 along the optical axis (or Z-axis) of lens group 205. In other words, the length of the turret in a direction (e.g., along X-axis) orthogonal to the optical axis (or Z-axis) may need to be only larger than a maximum diameter of the lenses of lens group 205 (e.g., lenses 205(1), 205(2), and 205(3)). By comparison, in FIG. 1A, the turret longitudinally (e.g., along X-axis) may need to accommodate light-folding element 110, lens group 105, and image sensor 115. Therefore, the length of the turret (e.g., along X-axis) may be reduced compared to that of camera 100, as indicated in FIGS. 1B and 2B. In some embodiments, the length of the turret may be less than the length of elongated light-folding element 210 along the direction (e.g., along X-axis) orthogonal to the optical axis (or Z-axis).

Note that, for purposes of illustration, FIG. 2A use a parallelogram prism to illustrate light folding element 210. In some embodiments, camera 200 may not necessarily use prism(s) but instead any suitable light folding element(s). In addition, in some embodiments, light folding element 210 may include other shapes, for example, a pentagon, a hexagon, and the like, and still provide the above described light folding functions and design benefits. In some embodiments, the lenses of lens group 205, e.g., lens 205(1) L1, lens 205(2) L2, and lens 205(3) L3, may be made from various light transmitting materials. For instance, lens group 205 may include a combination of both glass and plastic lenses. In another example, all the lenses of lens group 205 may be glass lenses, or plastic lenses. Plastics may provide less weight and lower material cost than glass. However, in some embodiments, using a glass lens for the first lens of a lens group (e.g., 205(1) L1 of lens group 205) may mitigate thermal focus shift within the optical system (e.g., camera 200). For instance, the thermal focus shift may be suppressed to less than 0.25 μm/degree. In some embodiments, using a material with a high Abbe number Vd (e.g., Vd>60) for the first lens of a lens group (e.g., 205(1) L1 of lens group 205) may correct axial color aberration. In some embodiments, all lenses of lens group 205 may use aspherical lenses. In some embodiments, all lenses of lens group 205 may use spherical lenses. In some embodiments, lens group 205 may include a combination of both aspherical and spherical lenses. A spherical lens may refer to a lens having a same curve across at least one surface like the shape of a ball, whilst an aspherical lens may refer to a lens having a surface which gradually changes in its curvature from the center of the lens out to the edge. In some embodiments, light folding element 210 may also include various optically transmitting materials, e.g., one or more glass prisms, one or more plastic prisms, or a combination of both glass prism(s) and plastic prism(s).

FIGS. 3A-3C are schematic cross-sectional views to show mounting of an optics assembly in an example camera, according to some embodiments. For purposes of illustration, only relevant elements within a partial portion of the camera (indicated by the dash lines in FIG. 3A) are shown in FIGS. 3A-3B. As shown in FIG. 3A, camera 300 may include optics assembly 330 and image sensor 315. Optics assembly 330 may include lens group 305, which may have one or more lenses, and light folding element 310. As shown in FIG. 3A, light folding element 310 may be arranged optically between lens group 305 and image sensor 315, such that light folding element 310 may redirect light passing through the one or more lenses of lens group 305 (e.g., by reflection at least at one surface of light folding element 310) to image sensor 315. In some embodiments, camera 300 may include an optional IR filter 325.

FIG. 3B shows a zoom-in cross-sectional view of the portion of camera 300, according to some embodiments. As shown in FIG. 3B, in some embodiments, light folding element 310 may be fixedly coupled with optics holder 335. In some embodiments, optics holder 335 may be one single piece. Alternatively, in some embodiments, optics holder 335 may include multiple parts. For instance, in some embodiments, optics holder 335 may include a lens holder for lens group 305 and a light folding element holder for light folding element 310. In some embodiments, lens group 305 may be affixed inside the lens holder using glue or other adhesive materials. Alternatively, in some embodiments, the lens holder may include threads inside the lens holder, and the one or more lenses of lens group 305 may be screwed in to lens holder via the threads to become fixedly coupled with the lens holder. The light folding element holder may have the size and geometry (e.g., a parallelogram shape) fitting light folding element 310 such that when light folding element 310 is placed within the light folding element holder, light folding element 310 may become tightly held by the light folding element holder. In some embodiments, light folding element 310 may be glued to the light folding element holder. The lens holder and the light folding element holder may then be assembled together to form optics holder 335. Because the lens group holder and the light folding element holder may be manufactured separately, such design can allow for flexibility to manufacturing, assembly, and/or sourcing of parts.

Referring back to FIG. 3B, in some embodiments, camera 300 may include stationary base 340. In some embodiments, stationary base 340 may include frame 345, such as a metal frame. In some embodiments, frame 345 may be formed using an insert molding process. For instance, the metal frame may be pre-formed and inserted into a mold, and plastic resin may be injected into the mold to form a non-metal such as a plastic portion of stationary base 340 within which the metal frame becomes an integrated part.

In some embodiments, optics assembly 330 may be attached to stationary base 340 by fixedly coupling optics holder 335 with stationary base 340 in various ways. For instance, optics holder 335 may be attached to a metal frame 345 using glue at joint 350, as shown in FIG. 3B. In addition, in some embodiments, stationary base 340 may be further attached to housing 355 of camera 300. For instance, in some embodiments, housing 355 may be made of metal, and the non-metal such as plastic portion of stationary base 340 may be glued to housing 355. With reference to the optical axis (or Z-axis) shown in FIGS. 3A-3B, at least a portion of stationary base 340 (e.g., frame 345) may be on the +Z side, whilst at least a portion of housing 355 (e.g., a bottom section of housing 355) may be on the -Z side. In some embodiments, the geometry of frame 345 may be customized with varying thickness to achieve high stiffness and/or good glue coverage area with optics holder 335.

In some embodiments, stationary base 340 may include a plastic portion, and optics holder 335 of optics assembly 330 may be attached to the plastic portion of stationary base 340, e.g., by welding optics holder 335 that may be made of plastics with the plastic portion of stationary base 340. In some embodiments, stationary base 340 may be entirely made of metal, e.g., using a computer numerical control (CNC) machining process. Accordingly, optics assembly 330 may be fixedly coupled with stationary base 340, e.g., by gluing optics holder 335 directly to the metal stationary base 340. Such a full-metal body design may further enhance the stiffness of stationary base 340 and provide better security to the mounting of optics assembly 330. Note that the above are only examples provided for purposes of illustration. In some embodiments, optics holder 335 and stationary base 340 may use various materials, and the two may be attached with each other using various appropriate approaches. Similarly, housing 355 of camera 300 may use various materials, and stationary base 340 may be attached to housing 355 in various appropriate ways based, at least in part, on the materials of the components.

FIG. 3C shows the structure of camera 300 in more details, according to some embodiments. As shown in FIG. 3C, lens group 305 and light folding element 310 may be fixedly attached with optics holder 335, e.g., at joints 352 and 354. For instance, lens group 304 may be fixedly coupled with optics holder 335 when screwed into threads of optics holder 335 at join 352, and light folding element 310 may be attached with optics holder 335 using glues at joint 354. Optics holder 335 may be further coupled with stationary base 340, e.g., using lead 345 at joint 350. Stationary base 340 may further be attached with housing 355 of camera 300. Therefore, optics assembly 330 (including lens group 305 and light folding element 310), stationary base 340, and housing 355 may collectively form one stationary piece, whilst image sensor 325 may be movable relative to stationary optics assembly 330 in multiple axes, e.g., along (1) Z-axis and (2) X- and/or Y-axis. For instance, image sensor 315 may be fixedly coupled with substrate 370. Substrate 370 may be further flexibly coupled with a stationary portion of camera 300 through one or more flexure connections. The flexure connections may provide necessary mechanical support for substrate 370 (and image sensor 315) but also allow for degrees of freedom in multiple axes.

FIG. 4 is an exploded view to show mounting of an optics assembly in an example camera, according to some embodiments. As described above, in some embodiments, optics holders 435 may include lens holder 460 (e.g., to hold lens group 305 in FIG. 3) and light folding element holder 465 (e.g., to hold light folding element 310), as shown in FIG. 4. In some embodiments, stationary base 440 may include frame 445 (such as a metal frame), e.g., at the side(s) of stationary base 440 facing at least a portion (e.g., corresponding to light folding element holder 465) of optics holder 435. As described above, in some embodiments, optics holder 435 may be fixedly coupled with stationary base 440, by attaching the portion (e.g., light folding element holder 465) of optics holder 435 to frame 445 of stationary base 440. In addition, in some embodiments, stationary base 440 may be fixedly coupled with housing 455, e.g., by gluing stationary base 440 to housing 455, as described above. As a result, optics holder 435 (holding optics assembly 430) may be at least partially placed within stationary base 440, and stationary base 440 may be at least partially placed within housing 455, as shown in FIG. 4.

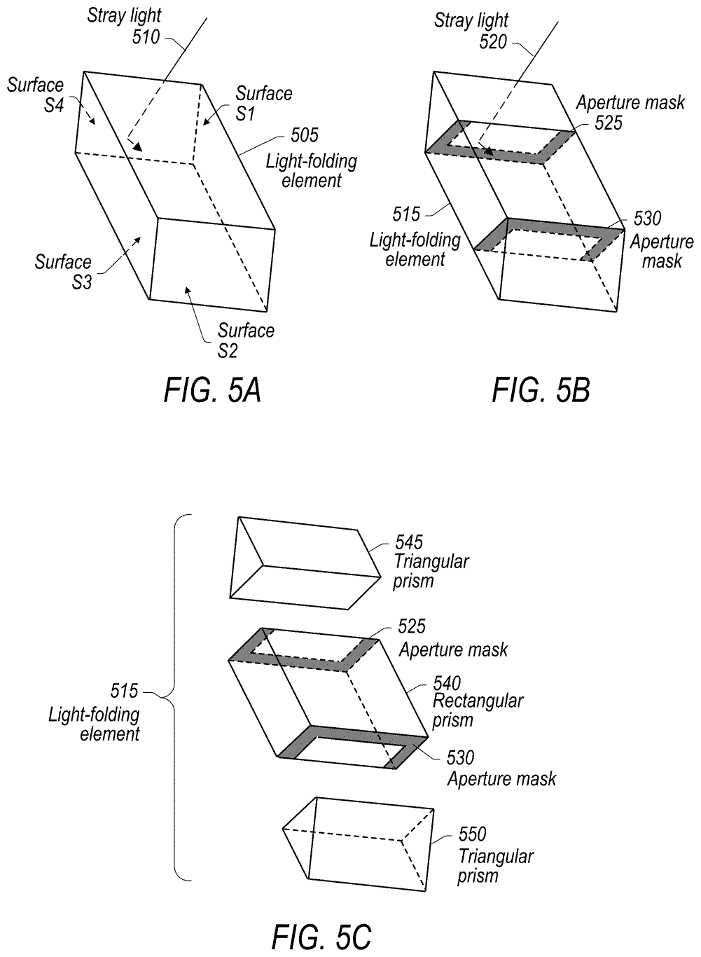

FIGS. 5A-5C show an example light folding element including aperture masks, according to some embodiments. In some embodiments, the aperture masks are provided to reduce or mitigate flare. For an optical system, flare may be caused when stray light from the environment, especially stray light brighter than light from the object which a camera is to capture, enters an optical system. The stray light from the environment may enter the optical system from various directions and/or other components of a camera (e.g., a side wall of a housing of the camera), and finally end up in the image. As shown in FIG. 5A, stray light 510 may enter light folding element 505, e.g., from a surface (e.g., Surface S4) of light folding element 505, e.g., including a prism. In some embodiments, a light folding element may include one or more aperture masks inside the light folding element and/or at a surface of the light folding element for reducing the flare. In this example, light folding element 515 may include aperture masks 525 and 530 inside light folding element 515 as shown in FIG. 5B. Further, in some embodiments, aperture masks 525 and/or 530 may be designed to have various shapes and/or sizes at various spatial positions. The purpose is to use aperture masks 525 and/or 530 to cover the areas supposedly to be hit by the stray light from the environment. This way, aperture masks 525 and/or 530 may intercept and absorb the stray light and thus reduce the flare, as shown in FIG. 5B.

For instance, as shown in FIG. 5B, aperture masks 525 and 530 may positioned parallel to each other at opposite sides inside light folding element 515 to mitigate flare caused by stray light coming from opposite sides (e.g., Surfaces S2 and S4) of prism 515. Note that FIG. 5A-5B are provided merely as examples for purposes of illustration. When the flare is caused by stray light coming from one or more other directions, the size, shape, and/or position of an aperture mask may be modified accordingly to achieve the desired anti-flare performance. In some embodiments, aperture masks 525 and/or 530 may individually include an anti-flare coating, dark (e.g., black-color) masking, dark (e.g., black-color) painting, change of flange shape, and the like.

In some embodiments, a light folding element (e.g., the light folding element in FIGS. 1-4) may include a single, one-piece prism. For instance, the light folding element may be a monolithic single piece prism, according to some embodiments. In some embodiments, the light folding element may be a hollow single piece prism with a cavity inside. In some embodiments, a light folding element may be created by joining together several prisms, e.g., with an optically clear cement. The latter approach may be used to create aperture masks inside a prism, according to some embodiments. For instance, as shown in FIG. 5C, light folding element 515 may be created by cementing prisms 540, 545, and 550. In this example, light folding element 515 may be in a parallelogram shape and thus may be created using one rectangular prism 540 and two triangular prisms 545 and 550. In some embodiments, to create aperture masks 525 and/or 530 inside prism 515, aperture masks 525 and/or 530 may be first created at respective surfaces of rectangular prism 540. For instance, aperture masks 525 and 530 may be created at two opposite, parallel surfaces of rectangular prism 540, as shown in FIG. 5C. Next, rectangular prism 540 (having aperture masks 525 and 530) may be cemented with triangular prisms 545 and 550, such that aperture masks 525 and 530 may be positioned at the respective joining surfaces between rectangular prism 540 and triangular prisms 545/550.

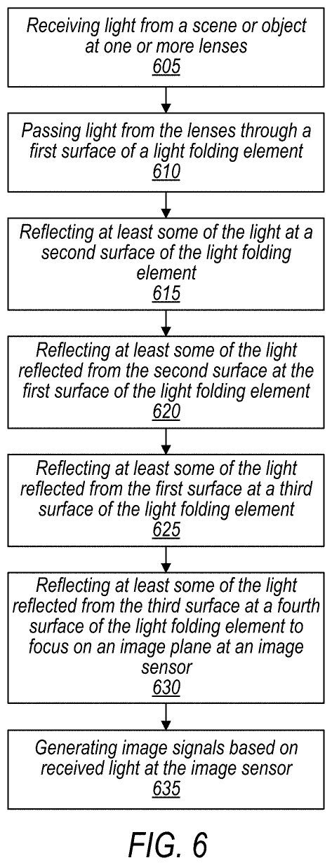

FIG. 6 shows a high-level flowchart of an example method for capturing images using a camera including a light folding element, according to some embodiments. As shown in FIG. 6, in some embodiments, one or more lenses (e.g., lenses 205(1)-205(3) in FIG. 2A) of a camera (e.g., camera 200 in FIG. 2A) may receive light from an object in an environment, as indicated by block 605. As described above, in some embodiments, the lenses may include at least three lenses having various materials, shapes, and/or sizes. In some embodiments, the camera may include a light folding element (e.g., light folding element 210 in FIG. 2A) which may be arrange optically between the lenses and an image sensor (e.g., image sensor 215 in FIG. 2A) of the camera. In some embodiments, the light folding element may include at least four surfaces (e.g., the four surfaces of a parallelogram prism in FIG. 2A) which may fold light within the light folding element at least four times to guide the light passing through the light folding element from the lenses to the image sensor.

As described above, in some embodiments, some surfaces of the light folding element (e.g., Surfaces S2 and S4) may individually include a reflective coating. Thus, in some embodiments, the light captured by the lenses may pass through a first surface (e.g., Surface S1 in FIG. 2A) of the light folding element to enter the light folding element, as indicated by block 610. In some embodiments, at least some of the light passing through the first surface may arrive at a second surface (e.g., Surface S2) of the light folding element and may be reflected at the second surface, as indicated by block 615.

In some embodiments, at least some of the light reflected from the second surface may bounce back to the first surface. As described above, when the incident angle of the light is close to or greater than a critical angle of the light folding element, TIR may occur and the light may be further reflected at the first surface of the light folding element, as indicated by block 620. In some embodiments, at least some of the light reflected from the first surface of the light folding element may transmit to and be reflected at a third surface (e.g., Surface S3) of the light folding element, as indicated by block 625. Similarly, when the incident angle of the light is close to or greater than the critical angle, the light may be reflected at the third surface of the light folding element, as indicated by block 625. In some embodiments, at least some of the light reflected from the third surface may reach and get reflected at a fourth surface (e.g., Surface S4) of the light folding element to exit the light folding element to focus on an image plane at the image sensor, as indicated by block 630. In some embodiments, the image sensor may detect the light and accordingly generate image signals, e.g., electrical signals, based on which images may be created, as indicated by block 635.

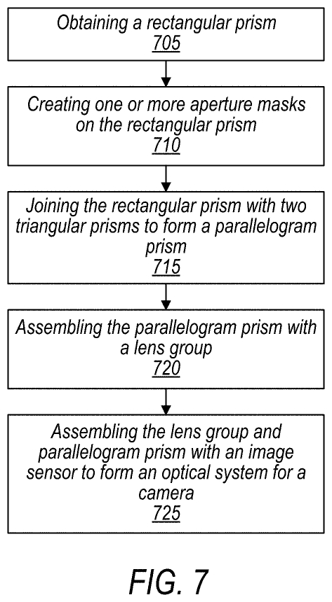

FIG. 7 shows a high-level flowchart of an example method for creating an optical system of a camera, according to some embodiments. FIG. 7 uses a parallelogram prism as the example for purposes of illustration, and the disclosed method may apply to prism(s) in other shapes and/or sizes as well. As shown in FIG. 7, the method may include obtaining a rectangular prism (e.g., rectangular prism 540 in FIGS. 5B-5C), as indicated by block 705. In some embodiments, one or more aperture masks (e.g., aperture masks 525 and/or 530) may be created at the rectangular prism to reduce flare, as indicated by block 710. For instance, the aperture masks may be created on two opposite, parallel surfaces of the rectangular prism (as shown in FIGS. 5B-5C). In some embodiments, the rectangular prism may be joined with one or more other prisms, e.g., two triangular prisms (e.g., triangular prisms 545 and 550), using optical cement to form a parallelogram prism (e.g., parallelogram prism 515), as indicated by block 715. In some embodiments, the aperture masks may be positioned at the joining surfaces between the triangular prism and respective triangular prisms (as shown in FIGS. 5B-5C).

In some embodiments, the parallelogram prism may be assembled with a lens group including one or more lenses (e.g., the lens group in FIGS. 1-4), as indicated by block 720. For instance, the parallelogram prism and the lens group may be assembled together such that a first surface (e.g., Surface S1) of the parallelogram prism may face a rear surface of a last lens (e.g., surface L3 S2 of lens 205(3) L3) of the lens group (as shown in FIG. 2A). Therefore, light captured by the lens group may pass through the lenses (e.g., from lens 205(1) L1, through lens 205(2) L2, and to lens 205(3) L3) of the lens group and then enter the prism through the first surface of the prism. In some embodiments, the lens group and parallelogram prism may be assembled with an image sensor (e.g., image sensor 215) to form an optical system for the camera (e.g., camera 200), as indicated by block 725. For instance, the lens group and parallelogram prism may be assembled with the image sensor such that a third surface (e.g., Surface S1) of the parallelogram prism opposite of (and parallel to) the first surface of the prism may face the image sensor (as shown in FIG. 2A). Therefore, the light from the lens group may enter the prism through the first surface, get folded inside the prism multiple times (e.g., at least four times), and pass through the third surface of the prism to the image sensor, as described above. In some embodiments, an infrared filter (e.g., infrared filter 225) may optionally be included between the prism and the image sensor in the camera to block or prevent at least some infrared light from reaching the image sensor.

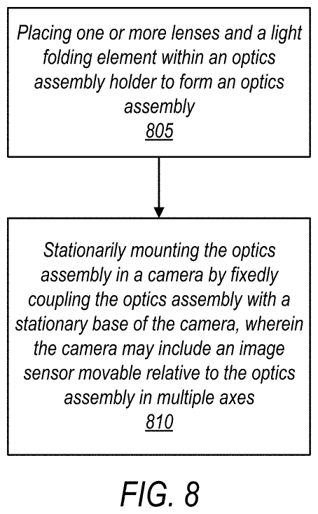

FIG. 8 is a high-level flowchart showing example techniques and methods for mounting an optics assembly in a camera, according to some embodiments. As shown in FIG. 8, in some embodiments, a lens group having one or more lenses and a light folding element may be placed within an optics holder to form an optics assembly, as described above in FIGS. 2-4, as indicated by block 805. As described above, in some embodiments, the optics holder may be one single piece. Alternatively, in some embodiments, the optics holder may include several parts that are assembled together. For instance, the lens group may be placed in a lens group holder, the light folding element may be placed in a light folding element holder, and the lens group holder (holding the lens group) and light folding element holder (holding the light folding element) may be put together to form the optics assembly. In some embodiments, the optics assembly may be stationarily mounted in a camera by fixedly coupling the optics assembly with a stationary base of the camera, as indicated by block 810. As described above in FIGS. 2-4, in some embodiments, the stationary base may include a frame, e.g., a metal frame insert molded into a plastic portion of the stationary base. The optics assembly may be fixedly coupled with the stationary base at least via a portion of the metal frame, e.g., by gluing the optics holder of the optics assembly with the metal frame of the stationary base. In some embodiments, the stationary base may include a plastic portion, and the optics assembly may be attached to the plastic portion of the stationary base, e.g., by welding or gluing the optics assembly with the plastic portion of the stationary base. In some embodiments, the stationary base may be entirely made of metal, and the optics assembly may be fixedly coupled with the stationary base, e.g., by gluing the optics assembly directly on to a portion of the metal stationary base. In addition, as described above in FIGS. 2-4, in some embodiments, the stationary base may be further fixedly coupled with a stationary housing of the camera. Furthermore, as described above in FIGS. 2-4, the camera may include an image sensor that may be movable, e.g., under the control of an actuator, relative to the optics assembly in more than one axis.

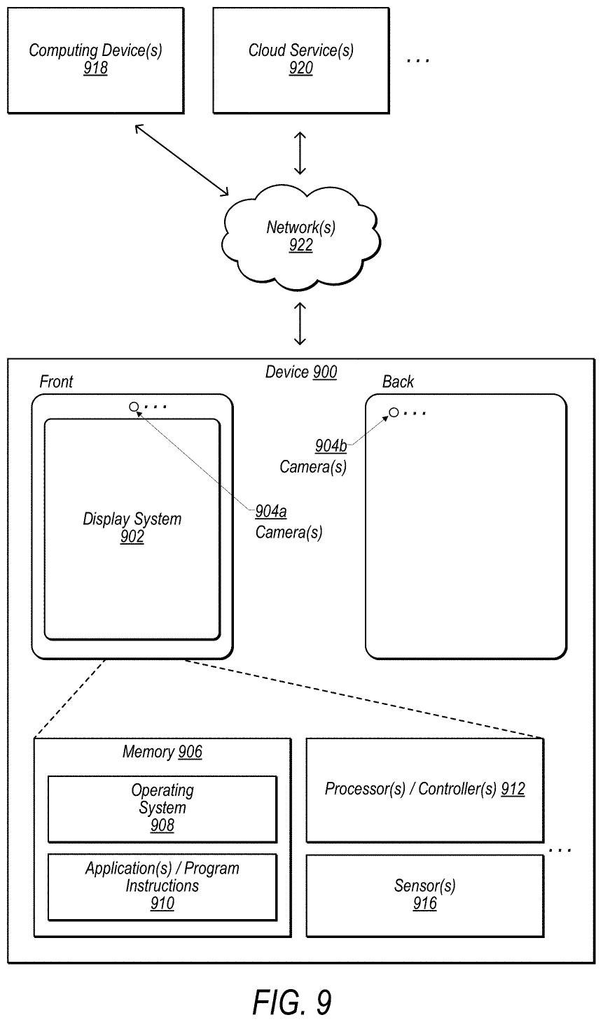

FIG. 9 illustrates a schematic representation of an example device 900 that may include a camera (e.g., the camera described above in FIGS. 1-8), in accordance with some embodiments. In some embodiments, the device 900 may be a mobile device and/or a multifunction device. In various embodiments, the device 900 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In some embodiments, the device 900 may include a display system 902 (e.g., comprising a display and/or a touch-sensitive surface) and/or one or more cameras 904. In some non-limiting embodiments, the display system 902 and/or one or more front-facing cameras 904a may be provided at a front side of the device 900, e.g., as indicated in FIG. 9. Additionally, or alternatively, one or more rear-facing cameras 904b may be provided at a rear side of the device 900. In some embodiments comprising multiple cameras 904, some or all of the cameras may be the same as, or similar to, each other. Additionally, or alternatively, some or all of the cameras may be different from each other. In various embodiments, the location(s) and/or arrangement(s) of the camera(s) 904 may be different than those indicated in FIG. 9.

Among other things, the device 900 may include memory 906 (e.g., comprising an operating system 908 and/or application(s)/program instructions 910), one or more processors and/or controllers 912 (e.g., comprising CPU(s), memory controller(s), display controller(s), and/or camera controller(s), etc.), and/or one or more sensors 916 (e.g., orientation sensor(s), proximity sensor(s), and/or position sensor(s), etc.). In some embodiments, the device 900 may communicate with one or more other devices and/or services, such as computing device(s) 918, cloud service(s) 920, etc., via one or more networks 922. For example, the device 900 may include a network interface (e.g., network interface 910) that enables the device 900 to transmit data to, and receive data from, the network(s) 922. Additionally, or alternatively, the device 900 may be capable of communicating with other devices via wireless communication using any of a variety of communications standards, protocols, and/or technologies.

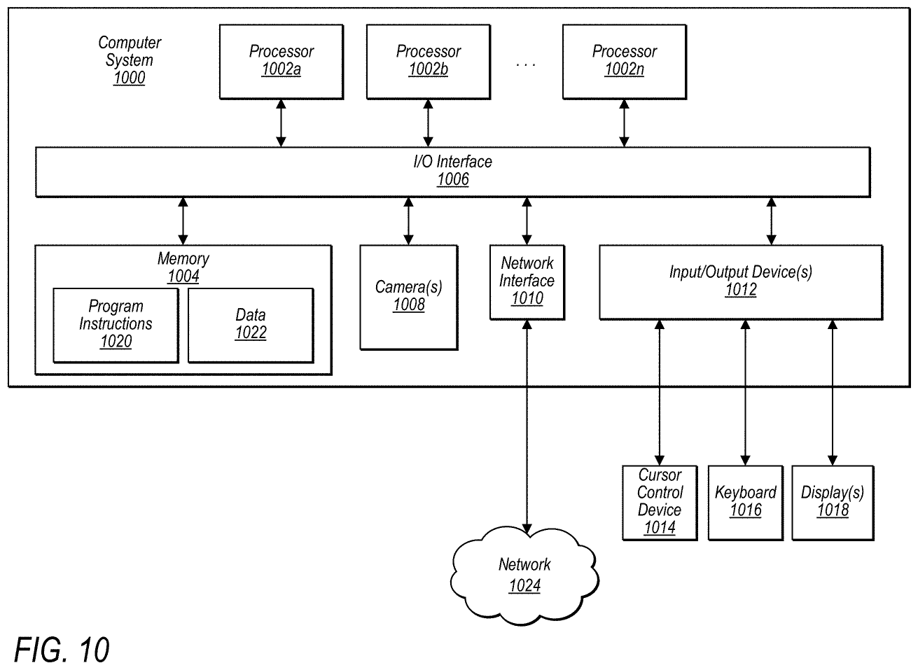

FIG. 10 illustrates a schematic block diagram of an example computing device, referred to as computer system 1000, that may include or host embodiments of a camera, e.g., as described herein with reference to FIGS. 1-9. In addition, computer system 1000 may implement methods for controlling operations of the camera and/or for performing image processing images captured with the camera. In some embodiments, the device 900 (described herein with reference to FIG. 9) may additionally, or alternatively, include some or all of the functional components of the computer system 1000 described herein.

The computer system 1000 may be configured to execute any or all of the embodiments described above. In different embodiments, computer system 1000 may be any of various types of devices, including, but not limited to, a personal computer system, desktop computer, laptop, notebook, tablet, slate, pad, or netbook computer, mainframe computer system, handheld computer, workstation, network computer, a camera, a set top box, a mobile device, an augmented reality (AR) and/or virtual reality (VR) headset, a consumer device, video game console, handheld video game device, application server, storage device, a television, a video recording device, a peripheral device such as a switch, modem, router, or in general any type of computing or electronic device.

In the illustrated embodiment, computer system 1000 includes one or more processors 1002 coupled to a system memory 1004 via an input/output (I/O) interface 1006. Computer system 1000 further includes one or more cameras 1008 coupled to the I/O interface 1006. Computer system 1000 further includes a network interface 1010 coupled to I/O interface 1006, and one or more input/output devices 1012, such as cursor control device 1014, keyboard 1016, and display(s) 1018. In some cases, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1002, or a multiprocessor system including several processors 1002 (e.g., two, four, eight, or another suitable number). Processors 1002 may be any suitable processor capable of executing instructions. For example, in various embodiments processors 1002 may be general-purpose or embedded processors implementing any of a variety of instruction set architectures (ISAs), such as the x86, PowerPC, SPARC, or MIPS ISAs, or any other suitable ISA. In multiprocessor systems, each of processors 1002 may commonly, but not necessarily, implement the same ISA.

System memory 1004 may be configured to store program instructions 1020 accessible by processor 1002. In various embodiments, system memory 1004 may be implemented using any suitable memory technology, such as static random access memory (SRAM), synchronous dynamic RAM (SDRAM), nonvolatile/Flash-type memory, or any other type of memory. Additionally, existing camera control data 1022 of memory 1004 may include any of the information or data structures described above. In some embodiments, program instructions 1020 and/or data 1022 may be received, sent or stored upon different types of computer-accessible media or on similar media separate from system memory 1004 or computer system 1000. In various embodiments, some or all of the functionality described herein may be implemented via such a computer system 1000.

In one embodiment, I/O interface 1006 may be configured to coordinate I/O traffic between processor 1002, system memory 1004, and any peripheral devices in the device, including network interface 1010 or other peripheral interfaces, such as input/output devices 1012. In some embodiments, I/O interface 1006 may perform any necessary protocol, timing or other data transformations to convert data signals from one component (e.g., system memory 1004) into a format suitable for use by another component (e.g., processor 1002). In some embodiments, I/O interface 1006 may include support for devices attached through various types of peripheral buses, such as a variant of the Peripheral Component Interconnect (PCI) bus standard or the Universal Serial Bus (USB) standard, for example. In some embodiments, the function of I/O interface 1006 may be split into two or more separate components, such as a north bridge and a south bridge, for example. Also, in some embodiments some or all of the functionality of I/O interface 1006, such as an interface to system memory 1004, may be incorporated directly into processor 1002.

Network interface 1010 may be configured to allow data to be exchanged between computer system 1000 and other devices attached to a network 1024 (e.g., carrier or agent devices) or between nodes of computer system 1000. Network 1024 may in various embodiments include one or more networks including but not limited to Local Area Networks (LANs) (e.g., an Ethernet or corporate network), Wide Area Networks (WANs) (e.g., the Internet), wireless data networks, some other electronic data network, or some combination thereof. In various embodiments, network interface 1010 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 1012 may, in some embodiments, include one or more display terminals, keyboards, keypads, touchpads, scanning devices, voice or optical recognition devices, or any other devices suitable for entering or accessing data by one or more computer systems 1000. Multiple input/output devices 1012 may be present in computer system 1000 or may be distributed on various nodes of computer system 1000. In some embodiments, similar input/output devices may be separate from computer system 1000 and may interact with one or more nodes of computer system 1000 through a wired or wireless connection, such as over network interface 1010.

Those skilled in the art will appreciate that computer system 1000 is merely illustrative and is not intended to limit the scope of embodiments. In particular, the computer system and devices may include any combination of hardware or software that can perform the indicated functions, including computers, network devices, Internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Generally speaking, a computer-accessible medium may include a non-transitory, computer-readable storage medium or memory medium such as magnetic or optical media, e.g., disk or DVD/CD-ROM, volatile or non-volatile media such as RAM (e.g. SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of the blocks of the methods may be changed, and various elements may be added, reordered, combined, omitted, modified, etc. Various modifications and changes may be made as would be obvious to a person skilled in the art having the benefit of this disclosure. The various embodiments described herein are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

What is claimed is:

1. A device, comprising
an optics assembly that includes a light folding element and a lens group having one or more lenses; and
an image sensor configured to be movable relative to the optics assembly in a direction parallel to an optical axis of the lens group and at least another direction orthogonal to the optical axis,
wherein the light folding element is configured to reflect light passing through the lens group at least at one surface of the light folding element to redirect the light to the image sensor, and
wherein the optics assembly is fixedly coupled with a stationary base of the device.

2. The device of claim 1, wherein the stationary base of the device comprises a metal frame, and wherein the optics assembly is fixedly coupled with the stationary base through the metal frame.

3. The device of claim 1, wherein the stationary base of the device comprises a plastic portion, and wherein the optics assembly is fixedly coupled with the plastic portion of the stationary base using plastic welding.

4. The device of claim 1, wherein the stationary base of the device is a metal stationary base, and wherein the optics assembly is fixedly coupled with the metal stationary base.

5. The device of claim 1, wherein the stationary base of the device is further fixedly coupled with a housing of the device.

6. The device of claim 5, wherein the optics assembly is positioned at least partially within the stationary base of the device, and wherein the stationary base of the device is positioned at least partially within the housing of the device.

7. The device of claim 1, wherein the light folding element comprises an elongated light folding element that has a length in a direction orthogonal to the optical axis larger than a height in the direction parallel to the optical axis of the lens group.

8. The device of claim 1, wherein the light folding element comprises a parallelogram prism having a first surface parallel to a third surface and a second surface parallel to a fourth surface, and wherein the first surface of the parallelogram prism is configured to face the lens group and the third surface of the parallelogram prism is configured to face the image sensor.

9. The device of claim 1, wherein the image sensor is configured to be movable using an actuator.

10. The device of claim 9, wherein the actuator comprises a voice coil motor (VCM) actuator.

11. A device, comprising:
a camera, comprising:
an optics assembly that includes a light folding element and a lens group having one or more lenses; and
an image sensor configured to generate image signals based on light from the optics assembly; and
a processor configured to process the image signals generated from the image sensor,
wherein the image sensor is configured to be movable relative to the optics assembly in a direction parallel to an optical axis of the lens group and at least another direction orthogonal to the optical axis,
wherein the light folding element is configured to reflect the light passing through the lens group at least at one surface of the light folding element to redirect the light to the image sensor, and
wherein the optics assembly is fixedly coupled with a stationary base of the camera.

12. The device of claim 11, wherein the stationary base of the device comprises a metal frame, and wherein the optics assembly is fixedly coupled with the stationary base through the metal frame.

13. The device of claim 11, wherein the stationary base of the device comprises a plastic portion, and wherein the optics assembly is fixedly coupled with the plastic portion of the stationary base using plastic welding.

14. The device of claim 11, wherein the stationary base of the device is a metal stationary base, and wherein the optics assembly is fixedly coupled with the metal stationary base.

15. The device of claim 11, wherein the stationary base of the device is further fixedly coupled with a housing of the device.

16. The device of claim 15, wherein the optics assembly is positioned at least partially within the stationary base of the device, and wherein the stationary base of the device is positioned at least partially within the housing of the device.

17. The device of claim 11, wherein the light folding element comprises an elongated light folding element that has a length in a direction orthogonal to the optical axis larger than a height in the direction parallel to the optical axis of the lens group.

18. The device of claim 11, wherein the light folding element comprises a parallelogram prism having a first surface parallel to a third surface and a second surface parallel to a fourth surface, and wherein the first surface of the parallelogram prism is configured to face the lens group and the third surface of the parallelogram prism is configured to face the image sensor.

19. A device, comprising
an optics assembly that includes a light folding element and a lens group having one or more lenses,
wherein the light folding element is configured to reflect light passing through the lens group at least at one surface of the light folding element to redirect the light to an image sensor of the device that is configured to be movable relative to the optics assembly in a direction parallel to an optical axis of the lens group and at least another direction orthogonal to the optical axis, and
wherein the optics assembly is fixedly coupled with a stationary base of the device.

20. The device of claim 19, wherein the stationary base of the device comprises a metal frame, and wherein the optics assembly is fixedly coupled with the stationary base through the metal frame.
